(19) United States
(12) Patent Application Publication
(10) Pub. No.: US 2025/0185117 A1
(43) Pub. Date: Jun. 5, 2025

(54) LOCATION UPDATE METHOD AND APPARATUS

(71) Applicant: ZTE Corporation, Shenzhen (CN)

(72) Inventors: Lin CHEN, Shenzhen (CN); Ying HUANG, Shenzhen (CN); Tao QI, Shenzhen (CN)

(21) Appl. No.: 18/991,194

(22) Filed: Dec. 20, 2024

Related U.S. Application Data
(63) Continuation of application No. PCT/CN2022/110940, filed on Aug. 8, 2022.

(51) Int. Cl. H04W 76/40; H04W 60/04; H04W 84/04; H04W 88/08

(52) U.S. Cl. CPC H04W 76/40; H04W 60/04; H04W 84/042; H04W 88/08

(57) ABSTRACT

Methods, apparatus and system for wireless communication are described. One example wireless communication method includes receiving, by an Integrated Access and Backhaul (IAB) node, area information, and broadcasting, by the IAB node, the area information. The receiving the area information may include receiving the area information from a donor central unit (CU), an IAB donor, a gNodeB (gNB), or an access and mobility management function (AMF).

### CROSS-REFERENCE TO RELATED APPLICATION

This application is a continuation and claims priority to International Application No. PCT/CN2022/110940, filed on Aug. 8, 2022, the disclosure of which is hereby incorporated by reference herein in its entirety.

### TECHNICAL FIELD

This patent document is directed generally to digital wireless communications.

### BACKGROUND

Mobile telecommunication technologies are moving the world toward an increasingly connected and networked society. In comparison with the existing wireless networks, next generation systems and wireless communication techniques will need to support a much wider range of use-case characteristics and provide a more complex and sophisticated range of access requirements and flexibilities.

Long-Term Evolution (LTE) is a standard for wireless communication for mobile devices and data terminals developed by 3rd Generation Partnership Project (3GPP). LTE Advanced (LTE-A) is a wireless communication standard that enhances the LTE standard. The 5th generation of wireless system, known as 5G, advances the LTE and LTE-A wireless standards and is committed to supporting higher data-rates, large number of connections, ultra-low latency, high reliability, and other emerging business needs.

### SUMMARY

Techniques are disclosed for performing a Tracking Area Update (TAU) for a User Equipment (UE) on-board a mobile Integrated Access and Backhaul (IAB) node that travels from a source donor Central Unit (CU) to a target donor CU.

A first example wireless communication method includes receiving, by an Integrated Access and Backhaul (IAB) node, area information, and broadcasting, by the IAB node, the area information.

A second example wireless communication method includes transmitting, by an Integrated Access and Backhaul (IAB) entity, IAB related information.

A third example wireless communication method includes transmitting, by a network function, context information associated with an inactive wireless device.

A fourth example wireless communication method includes transmitting, by a Radio Access Network (RAN) node, RAN area information.

A fifth example wireless communication method includes receiving, by a network function, an Inactive Radio Network Temporary Identifier (I-RNTI) associated with a wireless device, and transmitting, by the network function, location information associated with the wireless device.

A sixth example wireless communication method includes receiving, by a network function, an Inactive Radio Network Temporary Identifier (I-RNTI) associated with a wireless device. The method further includes transmitting, by the network function, a context retrieve request indication, and receiving, by the network function, context information associated with the wireless device.

A seventh example wireless communication method includes transmitting, by a network function, a Radio Access Network based Notification Area Update (RNAU) related indication.

In yet another exemplary embodiment, a device that is configured or operable to perform the above-described methods is disclosed. The device may include a processor configured to implement the above-described methods.

In yet another exemplary embodiment, the above-described methods are embodied in the form of processor-executable code and stored in a non-transitory computer-readable storage medium. The code included in the computer readable storage medium when executed by a processor, causes the processor to implement the methods described in this patent document.

The above and other aspects and their implementations are described in greater detail in the drawings, the descriptions, and the claims.

### BRIEF DESCRIPTION OF THE DRAWING

FIG. 1 illustrates an exemplary block diagram of an Integrated Access and Backhaul (IAB) network.

FIG. 2 illustrates an exemplary mobile IAB.

FIG. 3 illustrates an exemplary block diagram of a mobile IAB Distributed Unit (DU) changing a Tracking Area Code (TAC) with a served cell of a target donor DU.

FIG. 4 illustrates an exemplary block diagram of a mobile IAB DU changing a TAC configured by a target donor Central Unit (CU).

FIG. 5 illustrates an exemplary block diagram of a mobile IAB DU not changing a TAC broadcast by its served cell and keeping a TAC of a served cell of a new donor CU.

FIG. 6 illustrates an exemplary block diagram of configuring a dedicated tracking area along a trajectory of a mobile IAB node.

FIG. 7 illustrates an exemplary block diagram of a mobile IAB DU changing a Radio Access Network Area Code (RANAC) configured by a target donor CU.

FIG. 8 illustrates an exemplary block diagram of a mobile IAB DU not changing a RANAC.

FIG. 9 illustrates an exemplary block diagram of a User Equipment (UE) replacing an old New Radio Cell Global Identifier (NCGI) with a new NCGI for cells in a Radio Access Network based Notification Area (RNA).

FIG. 10 illustrates an exemplary block diagram of a target donor CU sending a location of an inactive UE to a last serving gNodeB (gNB).

FIG. 11 is an exemplary flowchart for transmission of area information.

FIG. 12 is an exemplary flowchart for transmission of IAB related information.

FIG. 13 is an exemplary flowchart for transmission of context information.

FIG. 14 is an exemplary flowchart for transmission of Radio Access Network (RAN) area information.

FIG. 15 is an exemplary flowchart for transmission of location information.

FIG. 16 is an exemplary flowchart for reception of context information.

FIG. 17 is an exemplary flowchart for transmission of RAN based Notification Area Update (RNAU) related information.

FIG. 18 illustrates an exemplary block diagram of a hardware platform that may be a part of a network device or a communication device.

FIG. 19 illustrates exemplary wireless communication including a Base Station (BS) and User Equipment (UE) based on some implementations of the disclosed technology.

### DETAILED DESCRIPTION

The example headings for the various sections below are used to facilitate the understanding of the disclosed subject matter and do not limit the scope of the claimed subject matter in any way. Accordingly, one or more features of one example section can be combined with one or more features of another example section. Furthermore, 5G terminology is used for the sake of clarity of explanation, but the techniques disclosed in the present document are not limited to 5G technology only, and may be used in wireless systems that implemented other protocols.

### I. Introduction

This patent document provides technical solutions for, among other things, a Tracking Area Update (TAU) or Radio Access Network (RAN) based Notification Area Update (RNAU) issue of UE served by mobile IAB node, which tries to reduce the number of area update and ensure the UE tracking reachability.

As the number of applications and services for digital data continues to increase, the demands and challenges placed on network resources and operators will continue to increase. Being able to deliver a wide variety of network performance characteristics that future services will demand is one of the primary technical challenges faced by service providers today. The performance requirements placed on the network will demand connectivity in terms of data rate, latency, QOS, security, availability, and many other parameters, all of which will vary from one service to the next. Thus, enabling a network to allocate resources in a flexible manner to provide customized connectivity for each different type of service will greatly enhance the network's ability to meet future demands.

To meet these demands, the development of 5th Generation (5G) mobile wireless technologies and standards are well underway. One such technology is a split network architecture where the Radio Access Network (RAN) functionality is split between a Central Unit (CU) and multiple Distributed Units (DUs). For example, RAN functions may be split at the point between the Packet Data Convergence Protocol (PDCP) layer and the Radio Link Control (RLC) layer of the 5G protocol stack, where DUs will handle all processes up to and including the RLC layer functions and the CU will handle PDCP layer and higher layer functions prior to the core network. This disaggregation of RAN functions will provide numerous advantages to mobile network operators. For example, through the isolation of the stack from the PDCP layer and upwards, the CU will be able to act as a Cloud-based convergence point among multiple heterogeneous technologies in the provisioned networks and hence will be able to serve multiple heterogeneous DUs.

Another technology being developed for 5G networks is an Integrated Access and Backhaul (IAB) architecture for providing high-speed wireless backhaul to cell sites (e.g., base stations). As data demands and the number of cell sites increase, it is becoming more difficult to provide traditional fiber optic backhaul access to each cell site, which is especially true for small cell base stations. Under the IAB architecture, the same infrastructure and resources (e.g., IAB nodes) can be used to provide both access and backhaul to support User Equipment (UE) Packet Data Unit (PDU) sessions, for example. The IAB architecture for New Radio (NR) networks will provide wireless backhaul and relay links enabling flexible and dense deployment of NR cells without the need for densifying the transport network proportionately. Additionally, IAB technologies will allow for easier deployment of a dense network of self-backhauled NR cells in a more integrated and robust manner. For example, the IAB technology in the 5G NR network will support a multi-hop relay system, where the network topology also supports redundant connections.

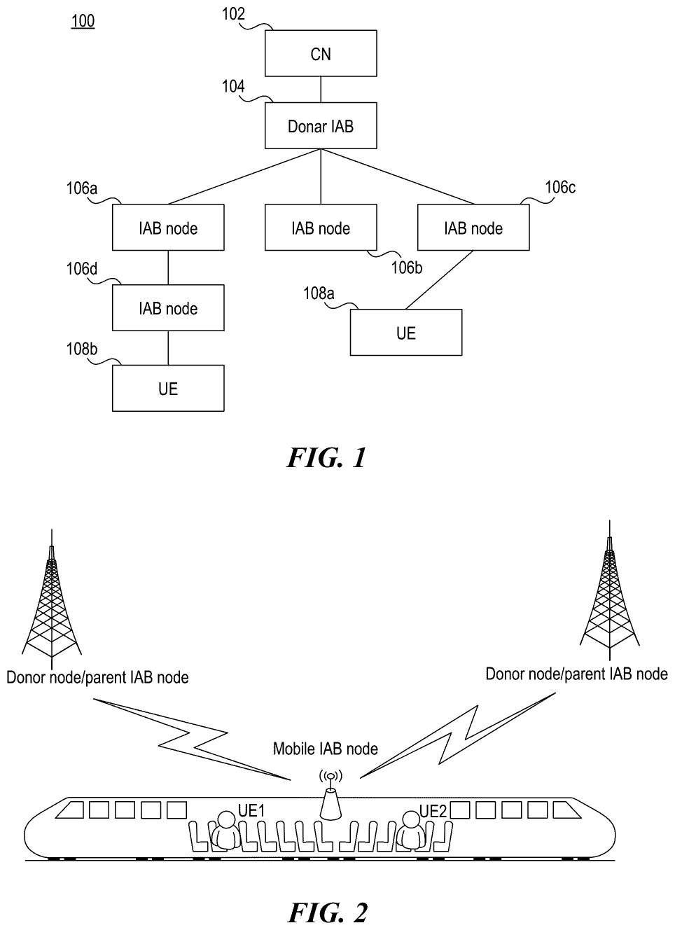

FIG. 1 illustrates a block diagram of an IAB architecture network 100 where a core network 102 is connected to a donor IAB node 104. As used herein, the term “connected” refers to a wired or cabled connection (e.g., a fiber optic cable) between two nodes or devices. The donor IAB node 104 is wirelessly coupled to a number of intermediate IAB nodes 106a and 106b and two serving IAB nodes 106c and 106d. As used herein, the term “coupled” refers to direct or indirect and wired or wireless communications between two nodes or devices.

As shown in FIG. 1, serving IAB nodes 106c and 106d are directly coupled to UEs 108a and 108b, respectively, and function as the serving cell site base stations or access points for the UEs 108a and 108b. The UEs 108a and 108b are referred to herein as “access UEs.” The serving IAB nodes 106c and 106d also function as relay and can forward their respective UE signals to their respective next uplink nodes in the transmission path, and forward downlink signals to their respective UEs 108a and 108b. As shown in FIG. 1, the serving IAB node 106c can forward uplink UE signals to one or both of the intermediate IAB nodes 106a and 106b, and receive downlink UE signals from one or both of the intermediate IAB nodes 106a and 106b. The intermediate IAB nodes 106a and 106b can forward uplink UE signals to the donor IAB node 104, and forward downlink signals to the serving IAB node 106d. The serving IAB node 106c can forward uplink UE signals to the donor IAB node 104, which can then forward all received signals to the core network 102, and can forward downlink signals from the donor IAB node 104 to the access UE 108a.

Each of the IAB nodes 106a-106d can have two functions: a base station (BS) function and a mobile terminal (MT) function. The BS function means the IAB node can work like a base station to provide the radio access function for a UE. As used herein, the “BS part” of an IAB node refers to that portion of the IAB node, including all hardware, firmware and/or software related to performing the BS functions of the IAB node. The MT function means the IAB node can work like a mobile terminal to be controlled and scheduled by the IAB donor node or an upper IAB node. As used herein the “MT part” of an IAB node refers to that portion of the IAB node, including all hardware, firmware and/or software related to performing the MT functions of the IAB node.

Referring still to FIG. 1, if the network 100 also implements a split architecture, the donor IAB node 104 would be replaced by a donor CU (not shown) connected to the core network 102 and a donor DU (not shown) connected to the donor CU. Each of the IAB nodes 106a-106d would be coupled to the donor DU in similar fashion to their coupling to the donor IAB node 104, as shown in FIG. 1.

In a split architecture network, each of the IAB nodes 106a-106d can have two functions: a DU function and a mobile terminal (MT) function. The DU function means the IAB node can work like a DU to provide the predetermined DU functions for a UE. As used herein, the “DU part” of an IAB node refers to that portion of the IAB node, including all hardware, firmware and/or software related to performing the DU functions of the IAB node. The MT function and MT part of an IAB node in a split architecture network is the same as described above for a non-split architecture network.

Based on the IAB architecture, the mobile IAB which focus on the scenario of mobile-IAB-nodes mounted on vehicles providing 5G coverage/capacity enhancement to on-board and/or surrounding UEs is proposed. To be specific, the mobile IAB can be used in outdoor environment to improve 5G coverage or connectivity, either following a certain known/predictable itinerary (e.g., buses, trams, etc.), or situated in convenient locations (e.g., outside stadiums, hot-spot areas, or emergency sites). The mobile IAB node provide connectivity for users or devices inside the vehicle itself and use 5G wireless backhaul toward the macro network. It is assumed that the mobile IAB may get better macro coverage than a nearby UE, e.g., exploiting better RF/antenna and power capabilities.

The implementation of the mobile IAB in the 5G network will raise many challenges. One such challenge is to reduce the location update signaling overhead of a group of UEs inside the vehicle along with the movements of mobile IAB node.

For the cellular system, RRC_IDLE state is introduced for power saving purpose. Generally speaking, the gNB broadcast a TAC (tracking area code) for each subset of PLMNs within a cell. Generally speaking, the TAC broadcast by gNB is configured by OAM and the corresponding tracking area is Earth-stationary. gNB will send the supported TAI (PLMN ID+TAC) list info of serving cell to the AMF. Based on this info, AMF can be aware the tracking area of each cell. For the UE, it may be configured with a list of TAI (i.e. registration area) from AMF when it was in RRC_Connected state. The AMF may take the TAI where the UE is geographically located into account to generate a suitable Registration Area for the UE.

When the UE enters RRC_IDLE state, it does not need to perform HO when it moves across different cells. Instead, the RRC_IDLE UE only need to perform periodic registration area update (RAU, may also be called as tracking area update, i.e. TAU) for UE reachability tracking and event-triggered RAU (i.e. when accessing a radio cell where none of the supported TACs for the RPLMN or equivalent to the RPLMN are part of the UE Registration Area) for UE registration area tracking. On the other hand, when the DL data for RRC_IDLE UE arrived, the AMF may send paging message to all the gNBs involved in the registration area of this UE. Upon receiving the paging message from AMF, gNB can determine which cell should be involved for the paging based on the TAI info. When the RRC_IDLE UE receive the paging message, the RRC_IDLE will enter RRC_Connected state and be ready for the DL data reception.

On the other hand, the RRC_INACTIVE state is also introduced for the power saving purpose. The RRC_INACTIVE UE may be configured by the last serving gNB with an RAN Notification Area (RNA). The RNA can cover one or multiple cells, and should be a subset of or equal to a CN Tracking Area. To be specific, the RNA may be configured via a list of cells or a list of RAN Area Code (RANAC) or TAC. On the other hand, a cell broadcasts one RAN area code in the SIB1. Generally speaking, this RAN area code is configured by OAM.

A RAN-based Notification Area Update (RNAU) is periodically sent by the UE and is also sent when the cell reselection procedure of the UE selects a cell that does not belong to the configured RNA. When UE performs RNAU, it may send the RRCResumeRequest to gNB, providing the I-RNTI allocated by the last serving gNB and appropriate cause value, e.g., RAN notification area update. If gNB is able to resolve the gNB identity contained in the I-RNTI, gNB may request the last serving gNB to provide UE Context. Finally, the UE may resume from RRC_INACTIVE to RRC_Connected/RRC_IDLE state or return back to RRC_INACTIVE state. Moreover, a RAN paging may be triggered due to incoming DL user plane, DL signaling from 5GC, etc. In this case, the RAN paging may be triggered in the cells controlled by the last serving gNB. In addition, it may be triggered by means of Xn RAN Paging in cells controlled by other gNBs, configured to the UE in the RNA. Suppose UE receive the paging with the I-RNTI of itself, the UE attempts to resume from RRC_INACTIVE to RRC_CONNECTED.

For the mobile IAB scenario, the mobile IAB node moves together with the vehicles, which may be across different registration areas, as shown in FIG. 2. The RAU in mobile IAB scenario has to deal with a large group of UEs and should be kept to minimum level. On the other hand, the UE reachability should be ensured. Similar to RAU, the RNAU in mobile IAB scenario also involve a large group of UEs and should be avoided. On the other hand, the UE reachability should be ensured. The potential solution examples try to address these issues.

### II. Example 1

In this example, we focus on the RAU or TAU issue in mobile IAB scenario.

### Example 1.1

In this example, the TAC broadcast by mobile IAB-node-DU is always aligned with parent DU or target donor CU when the mobile IAB node performs HO from source donor CU to target donor CU.

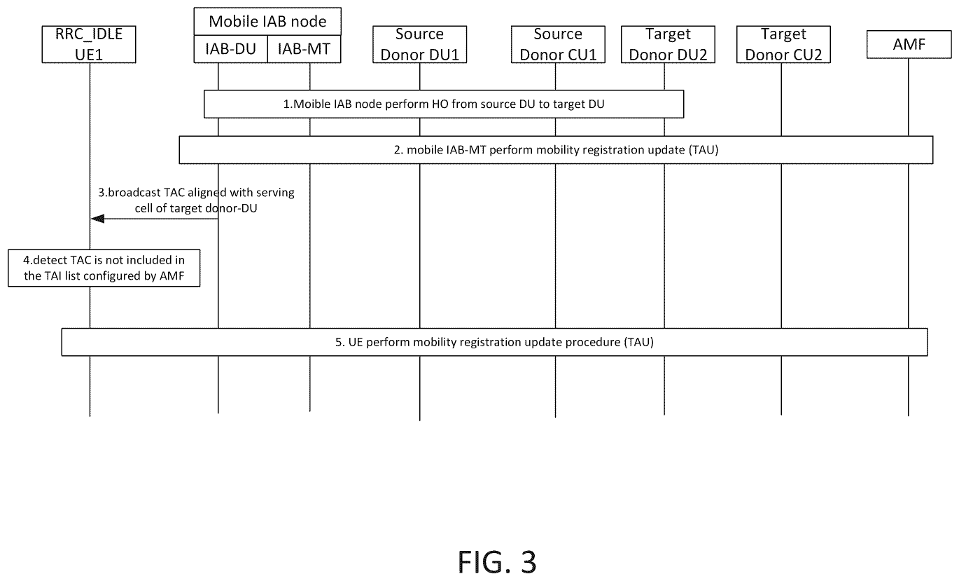

A passenger takes a UE and goes on the vehicle. A mobile IAB-node is mounted on the vehicle and provides access service to on-board UEs. When the vehicle moves, the mobile IAB-node and on-board UEs move as well. The mobile IAB-node may perform HO from source parent DU1 to target parent DU2. Source DU1 connects with source donor CU1 while target DU2 connects with target CU2. The mobile IAB-MT may detect that the current TAI of the serving cell is not in the list of TAIs that the mobile IAB-MT has received from AMF. In this case, the mobile IAB-MT determines that it is entering new TA and thus perform the tracking area update (TAU) procedure. During the TAU, the AMF will allocate a new set of tracking areas in TAI List to the mobile IAB-MT based on the current location of mobile IAB-MT. On the other hand, the co-located mobile IAB-DU may change the broadcast TAC value to align with the one broadcast by target parent DU as shown in FIG. 3.

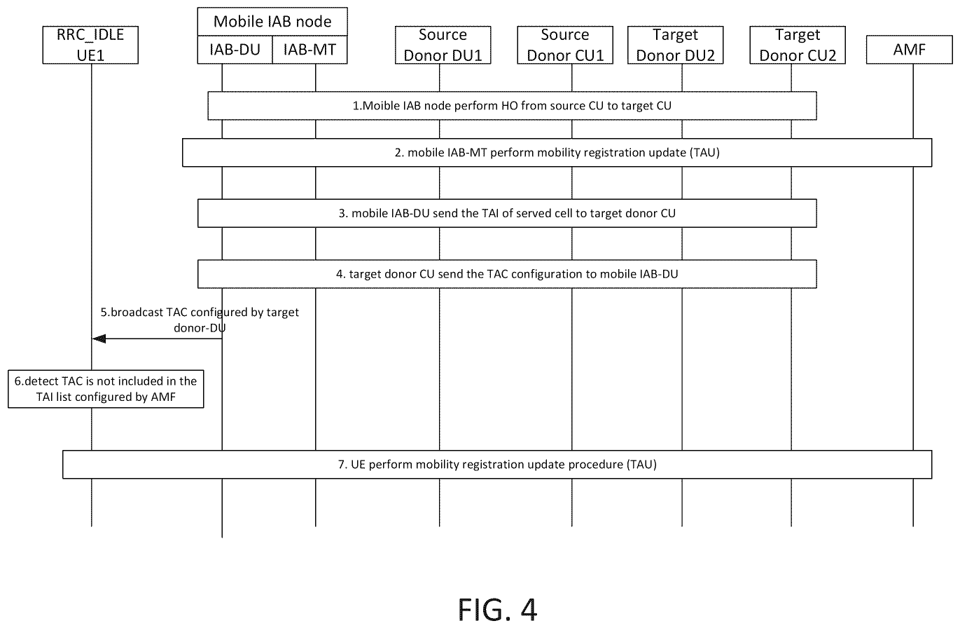

Alternatively, the target donor CU2 may detect the TAC of mobile IAB-DU served cell is different from the TACs of all the other served cells of donor CU (e.g., via the F1 setup and gNB-DU configuration update procedure), the donor CU may send the new TAC per PLMN configuration to mobile IAB-DU as shown in FIG. 4. Then mobile IAB-DU may broadcast the new TAC via SIB1. In this case, the UEs served by the mobile IAB-DU may initiate the TAU procedure if the UE finds that the broadcast TAC of the served cell is not within the TAI list allocated by the UE's AMF.

It should be noted that the mobile IAB node may only perform partial migration, i.e. the mobile IAB-MT performs HO from source donor CU to target donor CU while the co-located IAB-DU and descendant IAB node or UEs maintains the connection with source donor CU. In this case, since the mobile IAB-DU is still controlled by source donor CU, it is not necessary for the mobile IAB-DU to change the TAC broadcast via the SIB1 to align with the target donor CU or target parent DU.

### Example 1.2

In this example, the mobile IAB-DU does not change TAC broadcast by its served cell and keep the new donor CU of the TAC of its served cell.

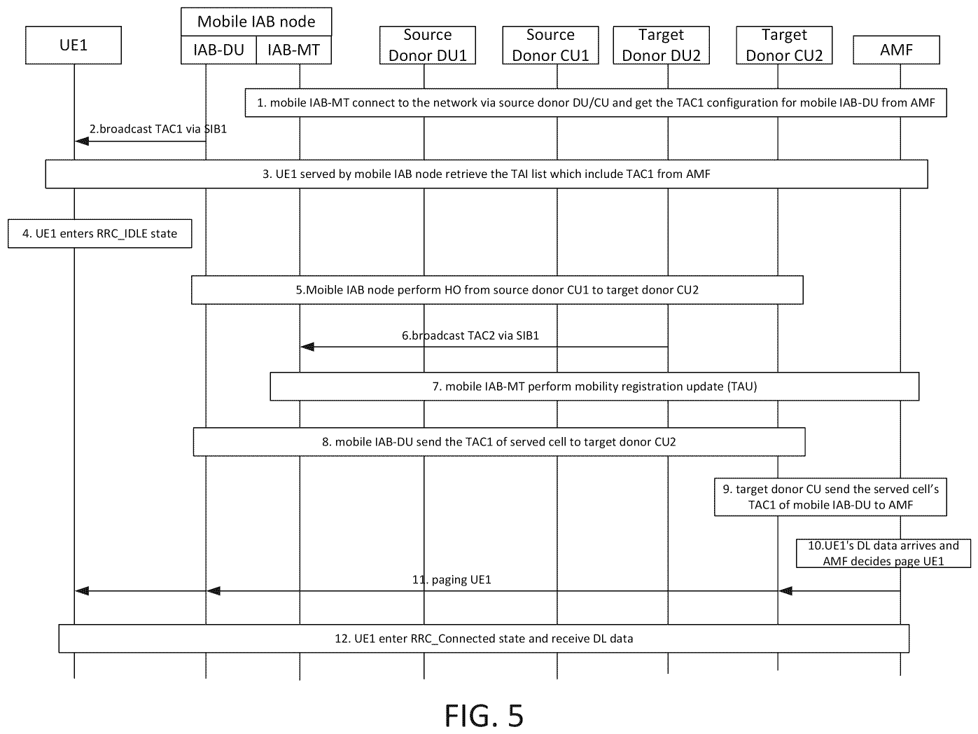

Mobile IAB-DU may be configured with a TAC1 for mobile IAB and mobile IAB-DU broadcast this TAC1 in SIB1. The TAC may be configured via OAM. Alternatively, the TAC for mobile IAB-DU may be received from AMF during the co-located mobile IAB-MT registration procedure as shown in FIG. 5. After that, the served cell of mobile IAB-DU broadcast TAC1 in SIB1.

On the other hand, UE1 connect to the network via the mobile IAB node and get the TAI list from AMF during the registration procedure. The TAI list assigned by the UE's AMF should contain this TAC1. This implies that the UE's AMF should know that the UE is served by mobile IAB node. Actually, donor CU may send the user location information to UE's AMF. The user location information sent by donor CU to AMF may include the NCGI, TAC, mobile IAB indication. After a while, UE1 enters RRC_IDLE state.

Later, the mobile IAB node performs HO from source donor CU1 to target donor CU2. The mobile IAB-MT may detect that the target donor DU2 broadcast TAC2. Then the mobile IAB-MT may perform the mobility registration area update procedure to retrieve a new TAI list which include the TAC2. On the other hand, the mobile IAB-DU may send the information of served cells (include the TAC1 and NCGI) to target donor CU2 via the F1 setup/gNB-DU configuration procedure. Upon receiving the mobile IAB node's served cell information, the target donor CU2 may send the supported TA list (including the TAC1) and NCGI information to AMF via RAN configuration update message. Then AMF should be aware of the TAC1 of mobile IAB-DU is under the control of target donor CU2.

Suppose the DL data of UE1 arrives, the AMF need to page the UEl served by the mobile IAB node within TAC1. AMF may send the paging message to the target donor CU2 which is involved in the TAC1 of mobile IAB-DU. Target Donor CU2 then send the paging message to mobile IAB-DU which broadcast the TAC1. Finally the UE1 served by the mobile IAB-DU may receive the paging message and enters RRC_Connected state to receive the DL data. Since the TAC1 broadcast by the mobile IAB-DU does not change with the movement, the RRC_IDLE UE served by the mobile IAB-DU will not detect the TAC change and TAU can be avoided.

### Example 1.3

In this example, the dedicated tracking area along the trajectory of mobile IAB node is configured.

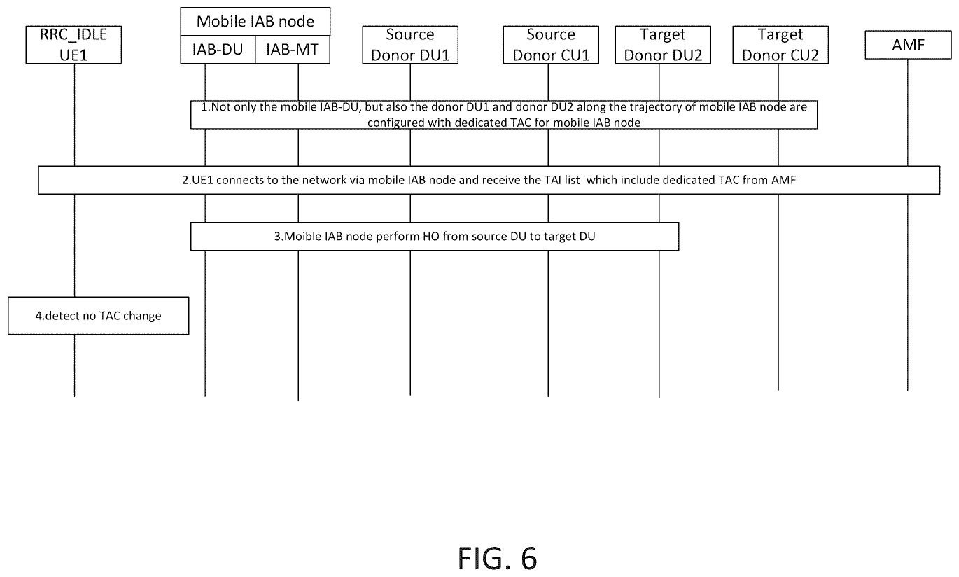

Suppose the trajectory of mobile IAB node is predictable, the potential parent DUs along the trajectory of mobile IAB node may be pre-configured with the dedicated TAC for mobile IAB node (in addition to the dedicated TAC, other normal TAC may also be configured for parent DUs) as shown in FIG. 6. On the other hand, both mobile IAB-DU and mobile IAB-node-MT may be configured with the dedicated TAC for mobile IAB and mobile IAB-DU broadcast this dedicated TAC in SIB1. When the mobile IAB node performs HO to a new target donor DU2, the mobile IAB-MT always detects that the current TAI of the serving cell is within the list of TAIs that the mobile IAB-MT has received from AMF. In this case, the mobile IAB-MT does not need to perform the tracking area update (TAU) procedure. Similarly, the mobile IAB-DU does not need to change the TAC broadcast in its served cell. Hence, the UE served by the mobile IAB node does not detect the tracking area change and the TAU can be avoided.

In order for the mobile IAB node be configured with dedicated TAC, the mobile IAB-MT may send the mobile IAB indication to AMF during registration procedure. Based on the mobile IAB indication, the AMF may configure a list of TAIs to mobile IAB-MT which include the dedicated TAC for mobile IAB. For the UEs served by the mobile IAB node, the TAI list assigned by the UE's AMF should contain this dedicated TAC. This implies that the UE's AMF should know that the UE is served by mobile IAB node, which may be achieved by the donor CU to report the user location information to UE's AMF. Moreover, the mobile IAB-MT may send the mobile IAB indication to donor CU. For the UE served by the mobile IAB node, donor CU may send the mobile IAB indication as part of the UE's user location information. The AMF may take the TAI where the UE is geographically located and or mobile IAB indication into account to generate a suitable Registration Area for the UE.

### III. Example 2

In this example, we focus on the RNAU issue in mobile IAB scenario. The RAN area is defined in terms of RANAC.

### Example 2.1

In this example, the RANAC broadcast by mobile IAB-node-DU is always aligned with parent DU or donor CU when the mobile IAB node performs HO from source donor CU1 to target donor CU2.

When the mobile IAB-node performs HO from source parent DU1 to target parent DU2, the mobile IAB-MT may detect that the RANAC of target parent DU2's cell is different from the broadcast RANAC of co-located mobile IAB-DU. In order to keep the UE reachability within RAN area, the mobile IAB-DU may change the broadcast RANAC to keep align with the serving cell of parent DU2.

On the other hand, when the mobile IAB node connects to target donor CU2, the mobile IAB-DU may send the information of served cells (include the NCGI, TAC and or RANAC) to target donor CU2 via the F1 setup/gNB-DU configuration procedure. Upon receiving the mobile IAB node's served cell information, the target donor CU2 may send the RANAC info of served cell of mobile IAB-DU to neighboring donor CU with Xn interface.

Target donor CU2 may detect the RANAC of mobile IAB-DU served cell is different from the RANACs of all the other served cells of target donor CU2 (e.g., via the F1 setup and gNB-DU configuration update procedure). In this case, the donor CU may regard this RANAC as not supported considering that Xn connection may be not available with last serving gNB of mobile IAB node. Therefore, the target donor CU2 may not be able to retrieve the UE context configured with this RANAC and the last serving gNB is not able to deliver the RNA paging message to the new donor DU of mobile IAB node. Based on this observation, it would be better for the target donor CU2 send the new RANAC per PLMN configuration to mobile IAB-DU. And mobile IAB-DU may broadcast the new RANAC per PLMN configuration via SIB1.

In this case, the RRC_INACTIVE UEs served by the mobile IAB-DU may initiate the RNAU procedure if the UE finds that the broadcast RANAC of the served cell is different from the RANAC configured by the UE's last serving gNB. During the RNAU procedure, the RRC INACTIVE UE1′s context may be retrieved from last serving gNB to target donor CU2. After the RNAU procedure, the RRC_INACTIVE UE may be reconfigured with the new RANAC and the target donor CU2 become the last serving gNB.

### Example 2.2

In this example, the RANAC of mobile IAB-node-DU is kept unchanged if the RANAC of mobile IAB-DU served cell is same as one of the RANACs of other served cells of donor CU.

When the mobile IAB node connects to a new donor node, the mobile IAB-DU may send the information of served cells (include the NCGI, TAC and or RANAC) to new donor CU via the F1 setup/gNB-DU configuration procedure. Upon receiving the mobile IAB node's served cell information, the new donor CU may detect if the RANAC of mobile IAB-DU served cell is same as one of the RANACs of other served cells of donor CU. In this case, the new donor CU may regard this RANAC as supported. The new donor CU does not need to request the mobile IAB node to change the RANAC configuration. It only needs to send the RANAC info of served cell of mobile IAB-DU to neighboring donor CU with Xn interface.

### Example 2.3

In this example, the RANAC of mobile IAB-node-DU is always unchanged. The RRC INACTIVE UE's context is transferred to target gNB during the HO of mobile IAB node.

Considering that the mobile IAB mode moves along with the vehicles, it is suggested that the RRC_IDLE/INACTIVE UE keeps camped on the served cells of mobile IAB node during the movement. Based on this observation, a specific RAN area which include the served cells of mobile IAB-node-DU can be defined.

If the UE moves from non-mobile node to mobile IAB node, it is very likely that the RANAC or NCGI is not within the previous RAN area configured at UE. In this case, the UE may perform RNAU and be configured with a new RAN area;

If the UE moves from mobile node to non-mobile node, it is very likely that the RANAC or NCGI is not within the previous RAN area configured at UE. In this case, the UE may perform RNAU and be configured with a new RAN area;

If the UE moves from mobile node to another mobile node, it is also very likely that the RANAC or NCGI is not within the previous RAN area configured at UE. In this case, the UE may perform RNAU and be configured with a new RAN area for the new mobile node;

Only when UE moves together with the mobile node, it is suggested to reduce the RNAU of UEs on the vehicle.

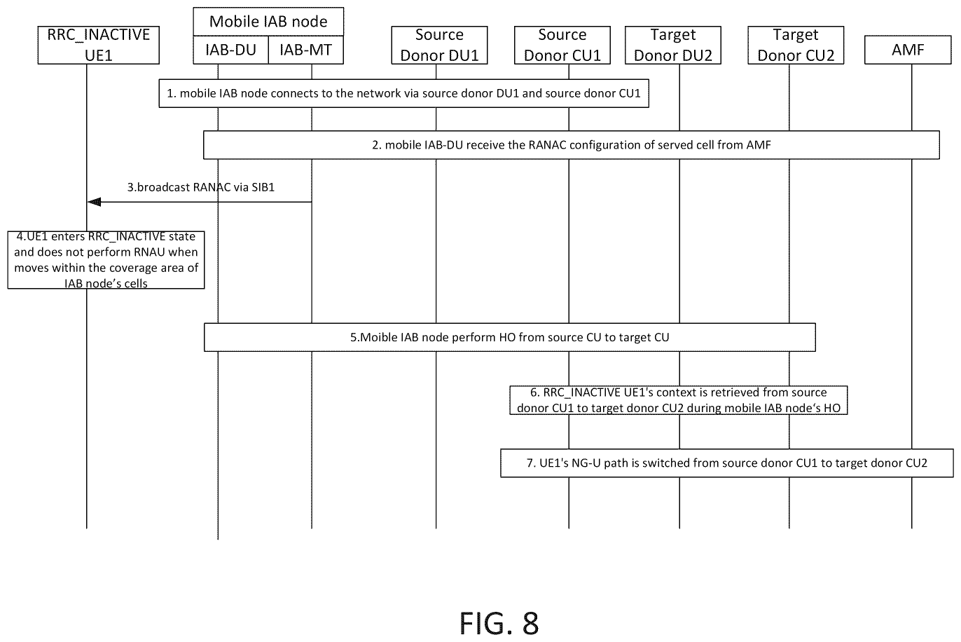

Suppose the RAN area of a specific mobile IAB node is defined in terms of RANAC and served cells of this mobile IAB node broadcast this RANAC. For RRC_INACTIVE UEs served by the mobile IAB node, it does not need to perform RNAU when it moves within the coverage area of mobile IAB node. However, when RRC_INACTIVE UE moves out of the mobile IAB node, it need to perform RNAU since the RAN area for mobile IAB node and other stationary node are different. In order to support the UE reachability, when the mobile IAB node performs HO from source gNB to target gNB, it is suggested that the source gNB send the UE context of RRC_INACTIVE UE to target gNB as shown in FIG. 8. In addition, the path switch for the RRC_INACTIVE UE from source donor CU1 to target donor CU2 should be performed. In this way, the RRC_INACTIVE UE is always reachable via the mobile IAB node.

With regard to the RANAC configuration of mobile IAB node, it can be configured by OAM or received from AMF or gNB-CU.

### Example 2.4

Suppose the trajectory of mobile IAB node is predictable, the potential parent DUs along the trajectory of mobile IAB node may be pre-configured with the dedicated RANAC for mobile IAB node (in addition to the dedicated RANAC, other normal RANAC may also be configured for parent DUs). On the other hand, the mobile IAB-node-DU may be configured with the dedicated RANAC for mobile IAB and mobile IAB-node-DU broadcast this dedicated RANAC in SIB1. When the mobile IAB node performs HO to a new target parent DU, the mobile IAB-node-MT always detects that the current RANAC of the serving cell is same with that of the co-located mobile IAB-node-DU has received from AMF. In this case, the mobile IAB-node-DU does not need to change the RANAC broadcast in its served cell. Hence, the UE served by the mobile IAB node does not detect the RNA change and the RNAU can be avoided.

### IV. Example 3

In this example, we focus on the RNAU issue in mobile IAB scenario. The RAN area is defined in terms of a list of cells.

### Example 3.1

Suppose the RAN area is defined in terms of a list of cells and UE is configured with a list of cells for RNA when entering into RRC_INACTIVE state, the UEs served by the mobile IAB-node-DU may detect that the NCGI change of mobile IAB-node-DU when the mobile IAB node performs HO. It is very likely that the new NCGI of mobile IAB-node-DU is not included in the list of cells for UE's RNA and the RRC_INACTIVE UE served by the mobile IAB-node-DU will perform the RNAU procedure. In order to reduce unnecessary RNAU of RRC_INACTIVE UE, the following options may be considered.

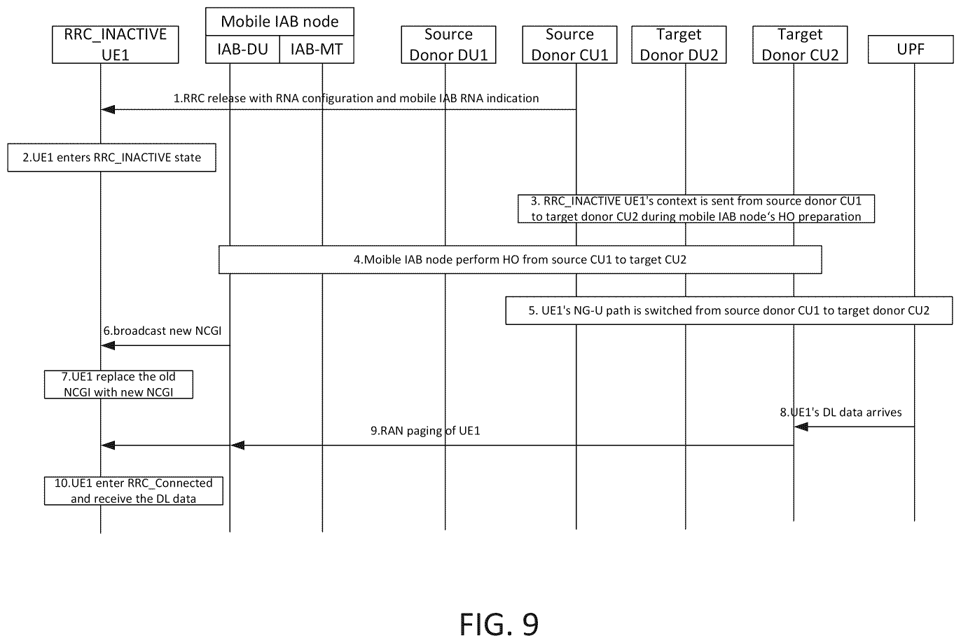

The UE initially connects to the network via a mobile IAB node. After a while, the gNB-CU sends RRC release message to UE and request UE to enter RRC_INACTIVE state. The RRC release message include the RAN area information. In addition, the RRC release message may include the mobile IAB RAN area indication as shown in FIG. 9. Based on this mobile IAB RAN area indication, the RRC_INACTIVE UE will perform the replacement of NCGI within the cell list of RAN area when the NCGI of served cells of mobile IAB node changes.

Suppose the mobile IAB node performs HO from source donor DU1/CU1 to target donor DU2/CU2 and the mobile IAB-node-DU is allocated/configured with new NCGI for its served cell, the served cell of mobile-node-DU may broadcast the change of NCGI from old to new one via SIB. Upon receiving the NCGI change, the UE served by the cells of mobile IAB-node-DU replace the old NCGI with the new one in its cell list of RAN area as shown in FIG. 8. Moreover, UE does not perform RNAU.

From the perspective of source donor CU1, it may send the UE context of RRC_INACTIVE UE served by the mobile-node-DU to target donor CU2 of mobile IAB node during the HO preparation procedure for mobile IAB node. In addition, the path switch should be performed and switch the NG path from source donor CU1 to target donor CU2. In this way, when the DL data of RRC_INACTIVE UE arrives at UPF, it may be delivered to the target donor CU2 currently serving the mobile IAB-node-DU. Then the target donor CU2 may deliver the RAN paging message to the mobile IAB-node-DU and the mobile IAB-node-DU broadcast the RAN paging message to RRC_INACTIVE UE.

### Example 3.2

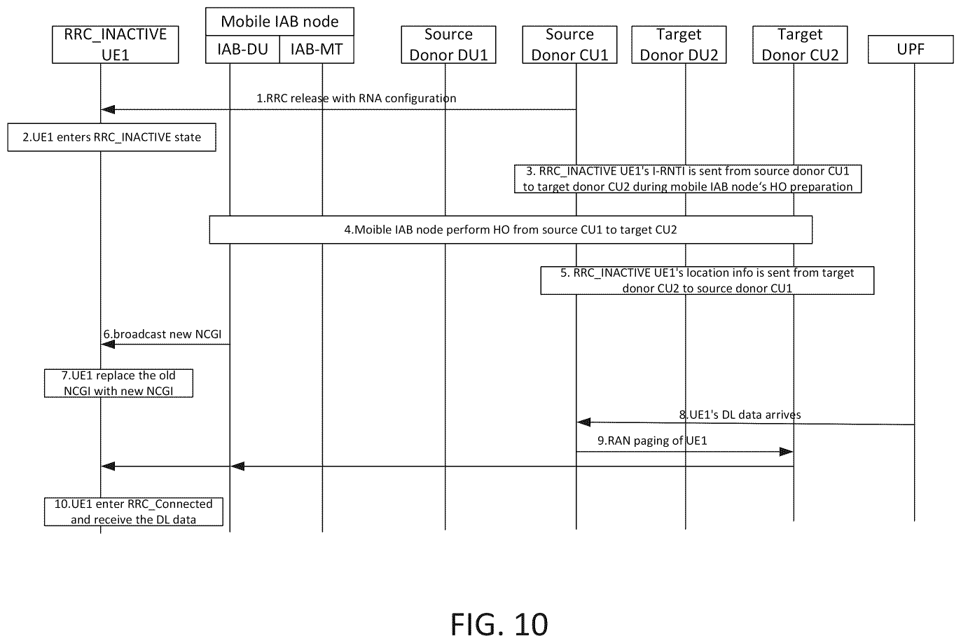

The RRC INACTIVE UE's context is stored in the last serving gNB (i.e. source donor CU1) of RRC_INACTIVE UE served by mobile IAB node. When the mobile IAB node perform HO from source donor CU1 to target donor CU2, the source donor CU1 send the I-RNTI of RRC_INACTIVE UE served by the mobile IAB node to target donor CU2 during the HO preparation procedure as shown in FIG. 10. If the target donor CU2 could identify the last serving gNB of the RRC_INACTIVE UE based on the I-RNTI and there is Xn connection between the target donor CU2 and last serving gNB, the target donor CU2 may send the location info (such as gNB ID, I-RNTI, NCGI, etc.) of RRC_INACTIVE UE to last serving gNB as shown in FIG. 10. Later when the last serving gNB need to page the RRC_INACTIVE UE, the last serving gNB is able to send the RAN paging message to the current serving gNB of RRC_INACTIVE UE camped on the mobile IAB node.

On the other hand, if the target donor CU2 cannot identify the last serving gNB of RRC_INACTIVE UE based on I-RNTI or there is no Xn connection between the target donor CU2 and last serving gNB, the target donor CU2 may also request the source gNB to acquire the RRC INACTIVE UE's context from last serving gNB and send it to target donor CU2. In addition, the target donor CU2 may request the path switch of RRC_INACTIVE UE from last serving gNB to target donor CU2.

Moreover, if the target donor CU2 cannot identify the last serving gNB of RRC_INACTIVE UE based on I-RNTI or there is no Xn connection between the target donor CU2 and last serving gNB, the target donor CU2 may do nothing. Later when RRC_INACTIVE UE performs RNAU, the target donor CU2 may requires the UE to set up new RRC connection. Or when the DL data of RRC_INACTIVE UE arrives at the last serving gNB, the last serving gNB may fail to reach the RRC_INACTIVE UE and the CN paging will be triggered to reach the RRC_INACTIVE UE.

### Example 3.3

The gNB or mobile-IAB-node-DU may send the RNAU disabled or enabled indication via system information. The gNB may also send the indication of RNAU disabled for a given RNAC via RRC release signaling. In addition, gNB-CU may send the RNAU disabled indication to mobile IAB-node-DU. When the RRC_INACTIVE UE receive such indication, it does not perform RNAU. It means that the current gNB or gNB-CU has already retrieve the UE context of RRC_INACTIVE UE served by the mobile IAB node. Even if the NCGI changes, the RRC_INACTIVE UE does not need to perform RNAU. On the other hand, if the RRC_INACTIVE UE moves to a cell which does not broadcast the RNAU disabled indication and the RRC_INACTIVE UE detects the RAN area changes, the RRC_INACTIVE UE shall performs the RNAU. Moreover, if the RRC_INACTIVE UE moves to a cell which broadcast the RNAU disabled indication and the configured RAN area of RRC_INACTIVE UE does not allow to disable RNAU, the RRC_INACTIVE UE still needs to perform RNAU when necessary.

### Example 3.4

Suppose the NGCI of served cells of mobile IAB-node-DU is specially configured, it does not cause NCGI collision and does not need to change with the gNB ID of donor CU. In this case, when the RAN area is configured by means of a list of cells, the RRC_INACTIVE UE served by the mobile IAB-node-DU will not detect RAN area change since the NCGI is included in the cell list of RAN area. So the RNAU will not be triggered due to RAN area change.

When the mobile IAB node perform HO from source gNB to target gNB, the source gNB send the I-RNTI of RRC_INACTIVE UE served by the mobile IAB node to target gNB during the HO preparation procedure. On the other hand, target gNB may send the location info (such as gNB ID, I-RNTI, NCGI, etc.) of RRC_INACTIVE UE to last serving gNB. Later when the last serving gNB need to page the RRC_INACTIVE UE, the last serving gNB is able to send the RAN paging message to the current serving gNB of RRC_INACTIVE UE camped on the mobile IAB node.

If the target gNB cannot identify the last serving gNB of RRC_INACTIVE UE based on I-RNTI or there is no Xn connection between the target gNB and last serving gNB, the target gNB may do nothing. Later when RRC_INACTIVE UE performs RNAU, the target gNB may requires the UE to set up new RRC connection. Or when the DL data of RRC_INACTIVE UE arrives at the last serving gNB, the last serving gNB may fail to reach the RRC_INACTIVE UE and the CN paging will be triggered to reach the RRC_INACTIVE UE.

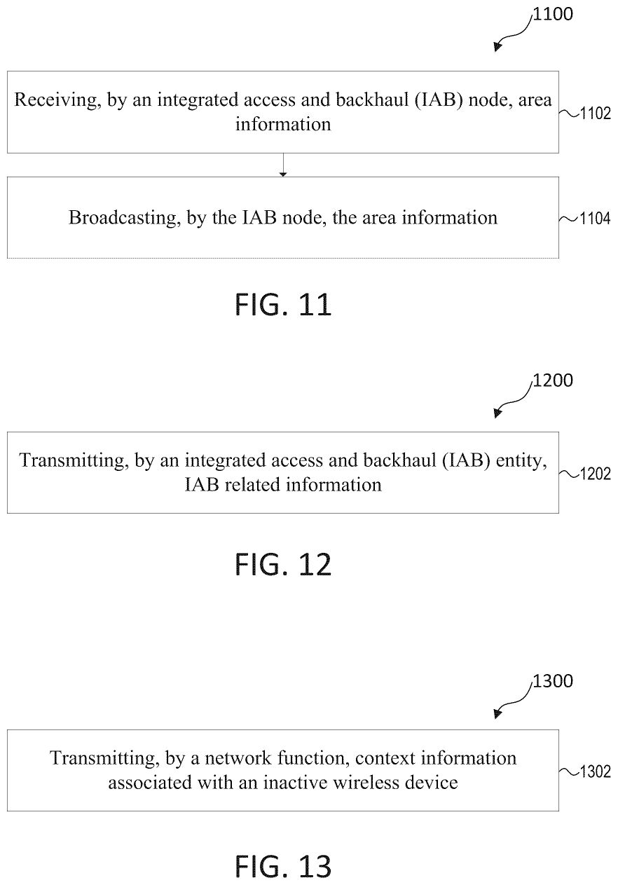

FIG. 11 is an exemplary flowchart for transmission of area information. Operation 1102 includes receiving, by an Integrated Access and Backhaul (IAB) node, area information. Operation 1104 includes broadcasting, by the IAB node, the area information. In some embodiments, the method can be implemented according to Example 1.1.

In some embodiments, receiving the area information includes receiving the area information from a donor Central Unit (CU), an IAB donor, a gNodeB (gNB), or an Access and Mobility Management Function (AMF). In some embodiments, the area information includes at least one of a cell identity, a Tracking Area Code (TAC), Public Land Mobile Network (PLMN) information, and a Radio Access Network Area Code (RANAC). In some embodiments, the TAC includes an old TAC or a new TAC, and the RANAC includes an old RANAC or a new RANAC.

FIG. 12 is an exemplary flowchart for transmission of IAB related information. Operation 1202 includes transmitting, by an Integrated Access and Backhaul (IAB) entity, IAB related information. In some embodiments, the method can be implemented according to Example 1.2.

In some embodiments, the IAB entity includes an IAB donor or an IAB node. In some embodiments, sending the IAB related information includes sending the IAB related information to an IAB donor or an Access and Mobility Management Function (AMF). In some embodiments, the IAB related information includes at least one of a New Radio Cell Global Identifier (NCGI), a Tracking Area Code (TAC), and a mobile IAB indication.

FIG. 13 is an exemplary flowchart for transmission of context information. Operation 1302 includes transmitting, by a network function, context information associated with an inactive wireless device. In some embodiments, the method can be implemented according to Example 2.3.

In some embodiments, the method further includes initiating, by the network function and prior to transmitting the context information, a handover or migration procedure for an Integrated Access and Backhaul (IAB) node serving the inactive wireless device or camped by the inactive wireless device. In some embodiments, the method further includes performing, by the network function, a path switch procedure for the inactive wireless device. In some embodiments, the network function includes a gNodeB (gNB) or a gNB Central Unit (CU). In some embodiments, sending the context information includes sending the context information to another network function including a gNB or a gNB CU.

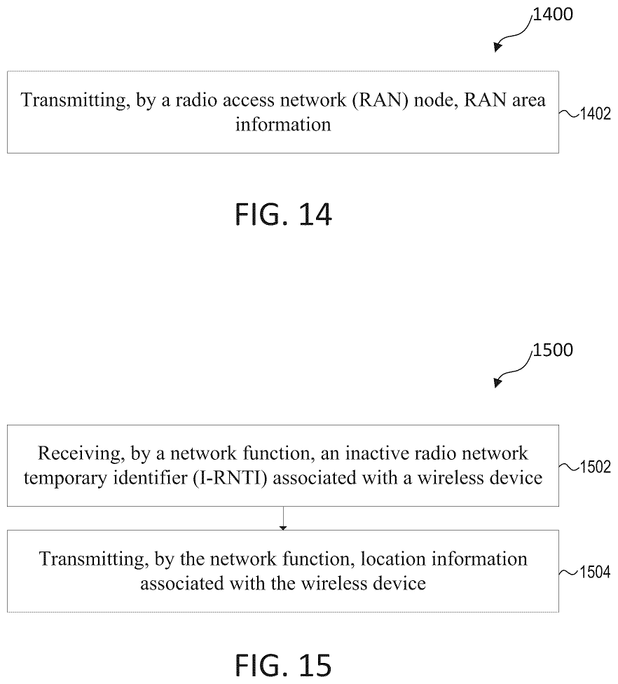

FIG. 14 is an exemplary flowchart for transmission of Radio Access Network (RAN) area information. Operation 1402 includes transmitting, by a Radio Access Network (RAN) node, RAN area information. In some embodiments, the method can be implemented according to Example 2.4.

In some embodiments, the RAN node includes a gNodeB (gNB) or an Integrated Access and Backhaul (IAB) donor. In some embodiments, sending the RAN area information includes sending the RAN area information to a wireless device. In some embodiments, the RAN area information includes at least one of a RAN Area Code (RANAC), a Tracking Area Code (TAC), a cell list, and a mobile IAB RAN area indication.

FIG. 15 is an exemplary flowchart for transmission of location information. Operation 1502 includes receiving, by a network function, an Inactive Radio Network Temporary Identifier (I-RNTI) associated with a wireless device. Operation 1504 includes transmitting, by the network function, location information associated with the wireless device. In some embodiments, the method can be implemented according to Example 3.2.

In some embodiments, the network function includes a target Integrated Access and Backhaul (IAB) donor of an IAB node serving the wireless device. In some embodiments, receiving the I-RNTI includes receiving the I-RNTI from a source IAB donor. In some embodiments, sending the location information includes sending the location information to a gNodeB (gNB) indicated by the I-RNTI. In some embodiments, the location information includes at least one of a gNB identity, an I-RNTI, a New Radio Cell Global Identifier (NCGI), and a Physical Cell Identity (PCI).

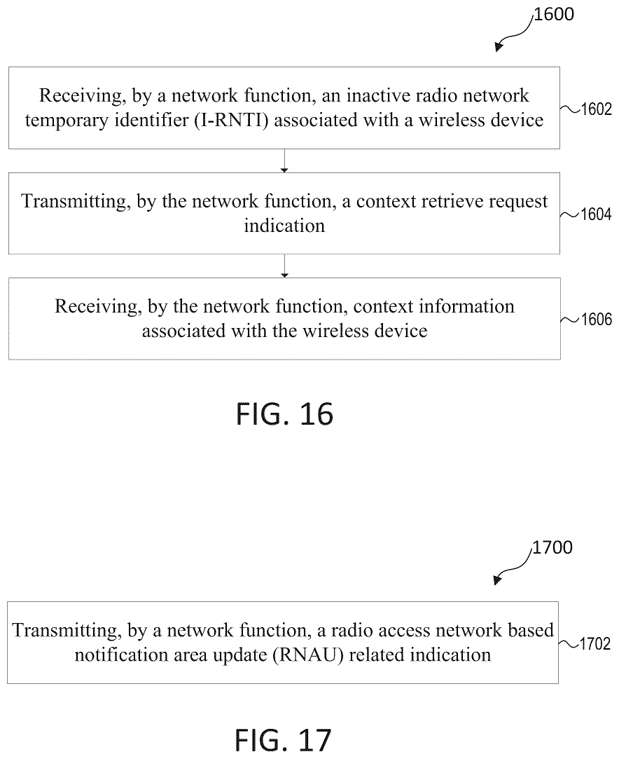

FIG. 16 is an exemplary flowchart for reception of context information. Operation 1602 includes receiving, by a network function, an Inactive Radio Network Temporary Identifier (I-RNTI) associated with a wireless device. Operation 1604 includes transmitting, by the network function, a context retrieve request indication. Operation 1606 includes receiving, by the network function, context information associated with the wireless device. In some embodiments, the method can be implemented according to Example 3.2.

In some embodiments, the network function includes a target Integrated Access and Backhaul (IAB) donor of an IAB node serving the wireless device. In some embodiments, receiving the I-RNTI includes receiving the I-RNTI from a source IAB donor, and sending the context retrieve request indication includes sending the context retrieve request indication to the source IAB donor. In some embodiments, the context retrieve request indication includes at least one of an identity of the wireless device and the I-RNTI. In some embodiments, receiving the context information includes receiving the context information from a source IAB donor or a gNodeB (gNB) indicated by the I-RNTI.

FIG. 17 is an exemplary flowchart for transmission of RAN based Notification Area Update (RNAU) related information. Operation 1702 includes transmitting, by a network function, a Radio Access Network based Notification Area Update (RNAU) related indication. In some embodiments, the method can be implemented according to Example 3.3.

In some embodiments, the network function includes a gNodeB (gNB), an Integrated Access and Backhaul (IAB) donor, an IAB Central Unit (CU), or an IAB Distributed Unit (DU). In some embodiments, sending the RNAU related indication includes sending the RNAU related indication to a wireless device. In some embodiments, sending the RNAU related indication includes sending the RNAU related indication via system information, Radio Resource Control (RRC) signaling, or a Media Access Control (MAC) Control Element (CE). In some embodiments, sending the RNAU related indication includes sending the RNAU related indication to an IAB node. In some embodiments, sending the RNAU related indication includes sending the RNAU related indication via F1 signaling, a RRC message, a MAC CE, or Backhaul Adaptation Protocol (BAP) layer information. In some embodiments, the RNAU related indication includes an enable indication or a disable indication.

A device that is configured or operable to perform the above-described methods are within the scope and the spirit of this patent document.

In some embodiments, the above-described methods are embodied in the form of processor-executable code and stored in a non-transitory computer-readable storage medium. The code included in the computer readable storage medium when executed by a processor, causes the processor to implement the methods described in this patent document.

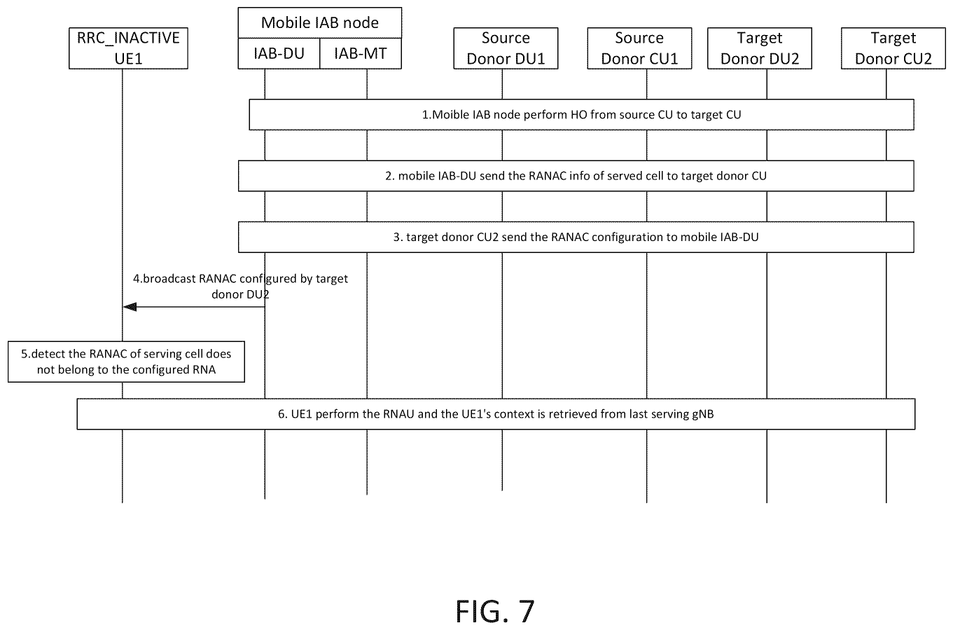

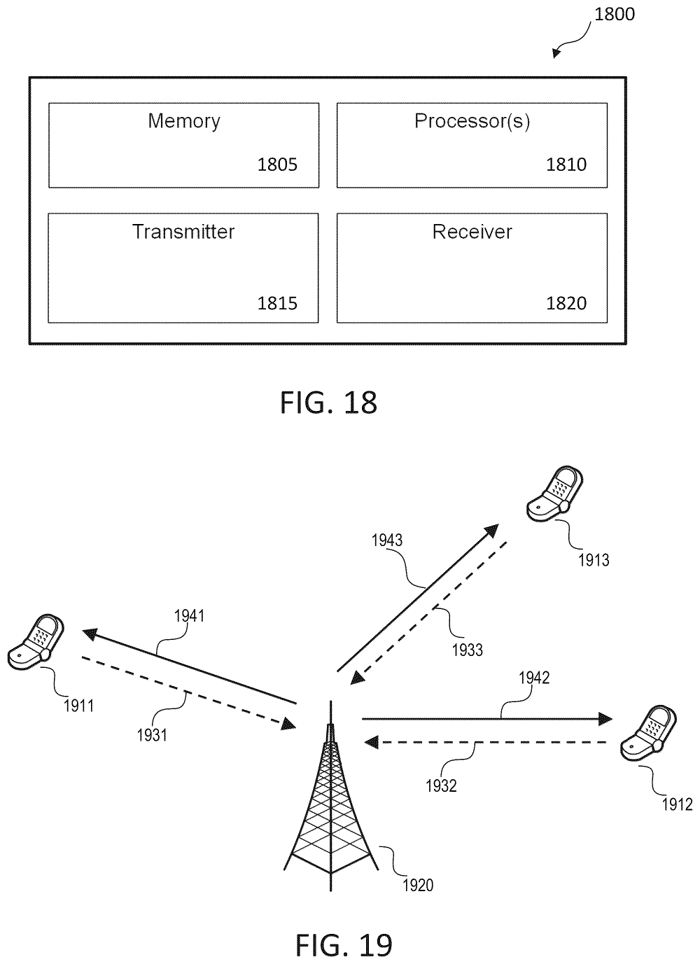

FIG. 18 shows an exemplary block diagram of a hardware platform 1800 that may be a part of a network device (e.g., base station) or a communication device (e.g., a user equipment (UE)). The hardware platform 1800 includes at least one processor 1810 and a memory 1805 having instructions stored thereupon. The instructions upon execution by the processor 1810 configure the hardware platform 1800 to perform the operations described in FIGS. 1 to 17 and in the various embodiments described in this patent document. The transmitter 1815 transmits or sends information or data to another device. For example, a network device transmitter can send a message to a user equipment. The receiver 1820 receives information or data transmitted or sent by another device. For example, a user equipment can receive a message from a network device. For example, an IAB node, an IAB entity, a network function, a RAN node, as described in the present document, may be implemented using the hardware platform 1800.

The implementations as discussed above will apply to a wireless communication. FIG. 19 shows an example of a wireless communication system (e.g., a 5G or NR cellular network) that includes a base station 1920 and one or more user equipment (UE) 1911, 1912 and 1913. In some embodiments, the UEs access the BS (e.g., the network) using a communication link to the network (sometimes called uplink direction, as depicted by dashed arrows 1931, 1932, 1933), which then enables subsequent communication (e.g., shown in the direction from the network to the UEs, sometimes called downlink direction, shown by arrows 1941, 1942, 1943) from the BS to the UEs. In some embodiments, the BS send information to the UEs (sometimes called downlink direction, as depicted by arrows 1941, 1942, 1943), which then enables subsequent communication (e.g., shown in the direction from the UEs to the BS, sometimes called uplink direction, shown by dashed arrows 1931, 1932, 1933) from the UEs to the BS. The UE may be, for example, a smartphone, a tablet, a mobile computer, a machine to machine (M2M) device, an Internet of Things (IoT) device, and so on. The network functions, IAB nodes, and IAB entity described in the present document may be communicatively coupled (e.g., as shown in FIG. 1) to UEs depicted in FIG. 19 thorough the base station 1920.

In this document the term “exemplary” is used to mean “an example of” and, unless otherwise stated, does not imply an ideal or a preferred embodiment.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer-or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

What is claimed is:

1. A method of wireless communication, comprising:
receiving, by an integrated access and backhaul (IAB) node, area information; and
broadcasting, by the IAB node, the area information.

2. The method of claim 1, wherein the receiving the area information comprises receiving the area information from a donor central unit (CU), an IAB donor, a gNodeB (gNB), or an access and mobility management function (AMF).

3. The method of claim 1, wherein the area information comprises at least one of a cell identity, a tracking area code (TAC), public land mobile network (PLMN) information, or a radio access network area code (RANAC).

4. The method of claim 3, wherein the TAC comprises an old TAC or a new TAC, and wherein the RANAC comprises an old RANAC or a new RANAC.

5. A method of wireless communication, comprising:
transmitting, by an integrated access and backhaul (IAB) entity, IAB related information.

6. The method of claim 5, wherein the IAB entity comprises an IAB donor or an IAB node.

7. The method of claim 5, wherein the transmitting the IAB related information comprises sending the IAB related information to an IAB donor or an access and mobility management function (AMF).

8. The method of claim 5, wherein the IAB related information comprises at least one of a new radio cell global identifier (NCGI), a tracking area code (TAC), and a mobile IAB indication.

9. An integrated access and backhaul (IAB) node, comprising a processor, wherein the processor is configured to implement a method of wireless communication, the method comprising:
receiving area information; and
broadcasting the area information.

10. The IAB node of claim 9, wherein the receiving the area information comprises receiving the area information from a donor central unit (CU), an IAB donor, a gNodeB (gNB), or an access and mobility management function (AMF).

11. The IAB node of claim 9, wherein the area information comprises at least one of a cell identity, a tracking area code (TAC), public land mobile network (PLMN) information, or a radio access network area code (RANAC).

12. The IAB node of claim 9, wherein the TAC comprises an old TAC or a new TAC, and wherein the RANAC comprises an old RANAC or a new RANAC.
